(19) United States
(12) Patent Application Publication
(10) Pub. No.: US 2025/0174934 A1
(43) Pub. Date: May 29, 2025

(54) SYSTEM FOR CONNECTING POWER OR FLUID LINES TO A FLOATING ENERGY CONVERTER DEVICE

(71) Applicant: APL Norway AS, Kolbjørnsvik (NO)

(72) Inventor: Geir Olav HOVDE, His (NO)

(21) Appl. No.: 18/842,566

(22) PCT Filed: Feb. 13, 2023
(86) PCT No.: PCT/NO2023/050033

§ 371 Date: Aug. 29, 2024

(30) Foreign Application Priority Data
Mar. 1, 2022 (NO) 20220261

(51) Int. Cl. H01R 13/523; F03D 9/25; H02G 1/10; H02G 9/12; H02G 15/14

(52) U.S. Cl. CPC H01R 13/523; F03D 9/255; H02G 1/10; H02G 9/12; H02G 15/14; F05B 2240/85; F05B 2240/93

(57) ABSTRACT

A connection system for connecting at least two cables to or from a floating energy converter device is provided, comprising at least two cables, a lower connection structure, and an upper connection structure, at least one longitudinal element joining the lower connection structure and the upper connection structure. The at least two cables run through the lower connection structure and each of the cables are connected to the upper connection structure and each comprises a connectable end at the upper connection structure, wherein the system is non-buoyant, and the at least one longitudinal element is a flexible longitudinal element.

### TECHNICAL FIELD

The present invention relates to a system for connection and disconnection of multiple power cables or fluid lines coming from other structures to a floating wind turbine or another floating energy converter device, where at least two of the cables or fluid lines can be connected to each other when the system is disconnected from the floating device, and where the power or fluid from the said floating device will be connected to least one of the multiple power cables or fluid lines when the system is connected to the floating device.

### BACKGROUND

For floating wind farms the increasing size of the wind turbines complicate maintenance and repair operations offshore due to non-existing or unmatured equipment and procedures for accessing and changing out heavy components at very high heights, which is further complicated by the challenges associated with the relative motions between the floating wind turbine and the maintenance/repair-vessel.

Floating wind farms are thus commonly planned such that major maintenance will be conducted at quayside, but this requires that the floating wind turbine requiring maintenance/repair must be disconnected from its mooring system and power cables and towed to shore. Since the wind turbine is connected to a grid of power cables, which connects the different wind turbines in the wind farm such as shown in FIGS. 2a and 2b, this typically means that the power circuit will be cut (open circuit) and power generation from several wind turbines will be off grid while the wind turbine towed to shore is being repaired.

Further, individual connection and disconnection of multiple power cables to and from the floating wind turbine is a time-consuming operation, which increases the time to first power delivery from the wind farm to the power grid. It also increases the time the floating wind turbine and the other affected wind turbines are disconnected from the grid. The solution with individual cable hang-off arrangements is illustrated in FIG. 3a.

A solution is thus presented which reduces the time for connection and disconnection and avoids stop in power production from other wind turbines when disconnecting one. The invention allows the multiple power cables to be connected and disconnected simultaneously and allows an intact (closed circuit) power circuit between the power cables when disconnected from the floating wind turbine. For shallow water the system is stored on the seabed when disconnected from the floating wind turbine, while for deep water a temporary buoy may be attached to keep the invention floating close to the sea surface.

Energy can be stored in different ways. Hydrogen and ammonia are two fluids frequently discussed in the industry suitable for energy storage and transport. The following description of the invention focus on transfer of energy via power cables but the invention can also be adopted for transport of fluids like water, hydrogen and ammonia.

One related prior art is disclosed in U.S. Pat. Nos. 10,421,524, 10,858,075, EP3212496 and EP3566941. Also this technology relates to a connection and disconnection system for multiple cables including a feature where the power circuit through the cables is intact when disconnected from the floating wind turbine. The system is however buoyant implying that it will float when disconnected and are thus less flexible with respect to hang-off location on the floating wind turbine since it will not be possible to hang-off inside the floating structure unless temporary clump weights are attached to the device during disconnection and connection. Further, this arrangement is not suited for storage on the seabed due to its buoyant nature and due to a very long rigid I-tube with length reflecting the height from the bottom of the floating wind turbine structure up to main deck. This invention is illustrated in FIG. 3b.

The main objectives of the present invention are to (a) maintain an electric circuit through the power cables when disconnected from the floating wind turbine, (b) be flexible on the hang-off position on the floating wind turbine (both internal and external hang-off to the floating structure), (c) in a simple way be able to lay-down on the seabed, store on seabed and pick-up from seabed, (d) be able to install and test the cables before the first hook-up to the floating wind turbine, and (e) be able to replace an individual power cable in a way similar to todays practice.

It is a further aim of the present invention to overcome the shortcomings of the known prior art.

To achieve these objectives, a system and method according to the independent claims are provided.

### SHORT SUMMARY OF THE INVENTION

The invention is set forth and characterized in the main claims, while the dependent claims describe other characteristics of the invention.

In a preferred embodiment of the invention a connection system for connecting at least two cables to or from a floating energy converter device is provided. The system comprising at least two cable, a lower connection structure and an upper connection structure, at least one longitudinal element joining the lower connection structure and the upper connection structure. The at least two cables run through the lower connection structure and each of the cables are connected to the upper connection structure and each comprises a connectable end at the upper connection structure, wherein the system is non-buoyant, and the at least one longitudinal element is a flexible longitudinal element. In a further embodiment of the invention the system further comprises a floating energy converter device. The floating energy converter device comprising an interfacing structure and a locking arrangement, wherein the upper connection structure is connectable to the floating device via the locking arrangement. Furthermore, the lower connection structure comprises an interfacing surface corresponding to the interfacing structure, wherein the interfacing surface is adapted to be in in contact with the interfacing structure when the system is connected to the floating energy converter device.

Further embodiments of the invention are set forth in the dependent claims.

In another aspect of the invention, the invention relates to a method for connecting a connection device and system to a floating energy converter device. The method comprises the steps of leading the upper connection structure, the longitudinal element, the lower connection structure and the cables into a guide tube of a floating energy converter device via temporary pull lines. Seating the lower connection structure into an interfacing structure of the floating energy converter device and locking the upper connection structure to the floating energy converter device or parts thereof, via a locking arrangement. Then the cables are connected to the floating energy converter device or parts thereof. Further embodiments of this aspect of the invention are set forth in the dependent claims.

In another aspect of the invention, the invention relates to a method for disconnecting a connection device and system to a floating energy converter device. The method comprises the steps of disconnecting the cables from the floating energy converter device or parts thereof, and connecting the cables to each other via connection means. Then disconnecting the upper connection structure from the locking arrangement and lowering, via temporary pull lines, the upper connection structure, the longitudinal element, the lower connection structure and the cables towards the seabed. Further embodiments of this aspect of the invention are set forth in the dependent claims.

### BRIEF DESCRIPTION OF THE FIGURES

Below, various embodiments of the invention will be described with reference to the figures, in which like numerals in different figures describes the same features.

FIG. 1a shows a bird perspective view of a typical floating wind turbine with three mooring lines and two power cables in shallow water.

FIG. 1b shows a side view of the same floating wind turbine as in FIG. 1a.

FIG. 2a shows a top view of a wind farm comprising seventy wind turbines arranged in a honeycomb configuration, where each floating wind turbine has three mooring lines (solid lines) and connected to an inter-array of power cables (dashed lines).

FIG. 2b shows a cut-out view of the same wind farm as shown in FIG. 2a.

FIG. 3a shows a typical power cable connection and hang-off arrangement for individual cables.

FIG. 3b shows a perspective view of an invention described in U.S. Pat. Nos. 10,421,524/10,858,075 for connection of multiple power cables to a floating wind turbine.

FIG. 4a shows a semi-submersible floater structure comprising 4 columns, whereof three columns are connected to mooring lines and the fourth column carries the wind turbine tower and the power cables.

FIG. 4b shows the same as FIG. 4a but illustrating the internal arrangement of the tower column with the guide tube for connection of multiple power cables.

FIG. 5a shows an alternative hang-off arrangement where the power cables are hung-off on the outside of the main floater structure instead of inside the floater structure.

FIG. 5b shows the disconnected part of the invention for an arrangement comprising two power cables.

FIG. 6a-f show a lay-down sequence of the invention in relation to disconnection for the alternative with external hang-off to the floater structure.

FIG. 7a-d show a lay-down sequence of the invention in relation to disconnection for the alternative with internal hang-off to the floater structure.

FIG. 8a-h show a lay-down sequence of the invention in relation to disconnection for the alternative with internal hang-off to the floater structure combined with temporary hold-back of power cables for smoother lay-down for very shallow water.

FIG. 9a shows an arrangement where the flexible structural element between the lower and upper connection structure comprises flexible pipes circumferencing the power cables.

FIG. 9b shows an arrangement where the flexible structural element between the lower and upper connection structure comprises a chain segment running parallel with the power cables.

FIG. 9c shows an arrangement where the flexible structural element between the lower and upper connection structure comprises a rope segment running parallel with the power cables.

FIG. 9d shows an arrangement where the flexible structural element between the lower and upper connection structure are the power cables themselves.

FIG. 10a shows a potential shape of the lower connection structure fitted for interfacing with a guide tube with constant cross-sectional area over the entire length.

FIG. 10b shows a potential shape of the lower connection structure fitted for interfacing with a guide tube having a conical shape at the lower end.

FIG. 11a shows an arrangement for the lower connection structure where

overbending of the dynamic cable is prevented by a bend stiffener which are connected to the lower connection structure via a bend stiffener latching mechanism.

FIG. 11b shows the same as FIG. 11a but where the bend stiffener is fixed to the lower connection structure by a bolted flange.

FIG. 11c shows an arrangement where the bend stiffener is replaced with a bellmouth structure.

FIG. 12a shows an arrangement where the invention is hung-off in a temporary buoy after it has been disconnected from the floating wind turbine.

FIG. 12b shows the same as FIG. 11a, but the temporary buoy is a buoy sued for hang-off of both the invention and the disconnected mooring lines for the floating wind turbine.

FIG. 13a shows the invention when connected to the floating wind turbine in a guide tube inside the floater structure.

FIG. 13b shows the same as FIG. 13a but in a bird view perspective.

FIG. 13c shows a close-up view of the lower connection structure.

FIG. 13d shows the same as FIG. 13c but from a different view angle.

FIG. 14a shows the invention with focus on the upper connection structure when connected to the floating wind turbine. Note that watertight compartment structure is shown as transparent such that the internals are seen.

FIG. 14b shows the same as FIG. 14a but here shown with the watertight compartment structure shown in an exploded view, where the different items are disconnected from each other.

FIG. 14c shows same as FIG. 14a but from a different view angle.

FIG. 14d shows same as FIG. 14a but from a different view angle.

FIG. 15a shows the connection line arrangement during connection and disconnection when invention is in a vertical orientation.

FIG. 15b shows the connection line arrangement when the invention is resting on the seabed in a horizontal orientation.

FIG. 16 shows the locking arrangement for the upper connection structure.

FIG. 17a shows a snapshot for the pull-in of the invention where the lower part of the upper connection structure is just below the hang-off deck, and where the hinged pads are at its nominal position (horizontal).

FIG. 17b shows a time step after FIG. 17a where the lower part of the upper connection structure pushes the hinged pads into vertical position.

FIG. 17c shows a time step after FIG. 17b where the lower part of the upper connection structure has passed the hinged pads such that they have fallen back into their nominal position (horizontal).

FIG. 17d shows a time step after FIG. 17c where the winch has lowered the upper connection structure onto the hinged pads and all loads on the winch has been relieved.

FIG. 17e shows a time step after FIG. 17d where the jacks has been used to pretension the flexible element joining the upper and lower connection structure such that the lower connection structure is in full contact with the floater structure. The structural hang-off of the system to the floater is completed.

FIG. 17f shows the same as FIG. 17e but from another view angle.

FIG. 18a shows the natural seawater level inside the guide tube and the flexible hose due to the natural openings in and around the lower connection structure.

FIG. 18b shows the scenario with active water-filling into the flexible hose.

FIG. 18c shows the scenario with active water-filling into the guide tube.

FIG. 19a shows an additional arrangement to the alternatives shown in FIG. 9 when connected to the floater structure.

FIG. 19b shows same as FIG. 19a but in the disconnected configuration.

### DETAILED DESCRIPTION OF THE INVENTION

The following description will use terms such as “horizontal”, “vertical”, “lateral”, “back and forth”, “up and down”, “upper”, “lower”, “inner”, “outer”, “forward”, “rear”, etc. The longitudinal direction is defined as the direction along a central axis. These terms generally refer to the views and orientations as shown in the drawings and that are associated with a normal use of the invention. The terms are used for the reader's convenience only and shall not be limiting. Like numerals on different drawings describe the same feature. Numerals with apostrophe represents an additional feature represented by the same numeral, for instance the number 11 will represent one or the first of multiple or all of the multiples, and the numeral 11′ represents an additional or a further of the same feature, like a second or multiple of the same feature.

The invention describes a system for connecting or disconnecting multiple power cables to a floating wind turbine, which can be connected to or disconnected as one unit to or from the floating wind turbine, and where the electrical circuit between the cables are maintained (i.e. open circuit) during this disconnected state, implying that the neighbor wind turbines on the same grid line are not prevented from supplying power to the grid.

The description of the invention is focusing on a device for two power cables as an example. The invention is however not limited to this number of cables but can easily also be adopted for more than two cables. In cases with an odd number of cables, the extra cable, if not connectable to any other cable may be capped or plugged. The invention in a simpler version can also be used for a single power cable even though the requirement for an open electrical circuit is not present.

The system comprises a lower connection structure, which provides the rotational fixation point between the floating wind structure and the power cables at a lower elevation (typically below the water line), an upper connection structure, which provides the axial fixation point between the floating wind structure and the power cables at an upper elevation (typically above the water line), a flexible structural element joining the lower and upper structure, a compartment for the electrical connectors (typically watertight), which are integrated into the upper connection structure, and means for connecting a connection line to the upper connection structure for lifting and lowering the invention during connection and disconnection. The connection line is connected to a winch or a supporting vessel at the other end. The system also includes a lower mating structure on the floating wind turbine for the structural contact point with the lower connection structure, and a hang-off deck with a locking arrangement for the upper connection structure.

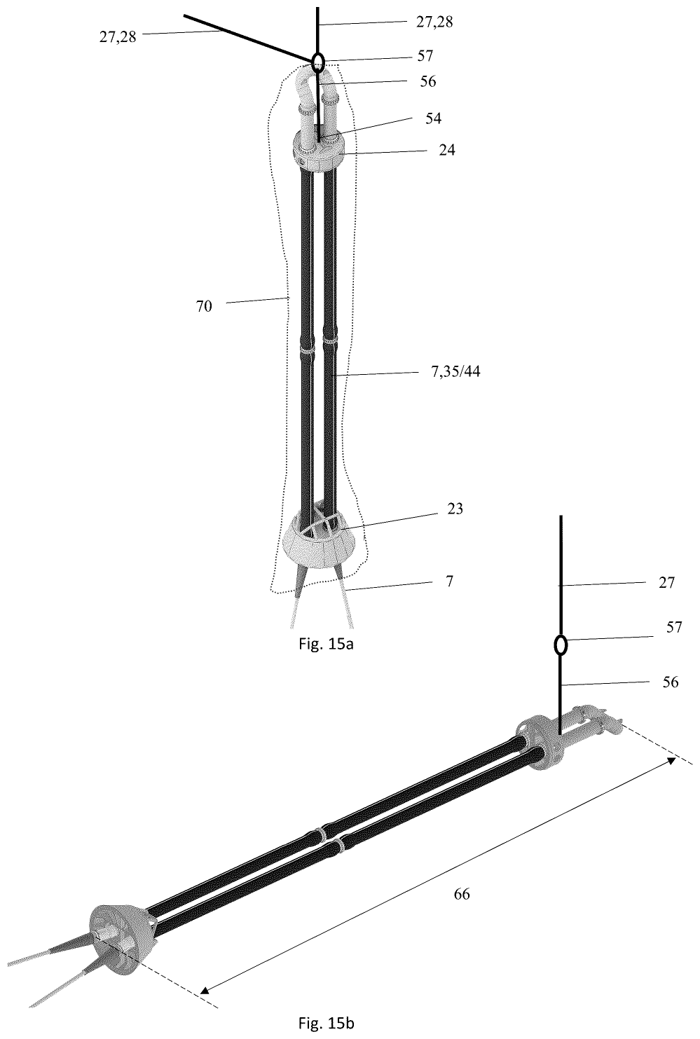

The system is non-buoyant and will rest on the seabed when disconnected from the floating wind turbine. Non-buoyant means that the system or arrangement 70 (exemplified in FIG. 15a and FIG. 19) will sink to the seabed 3 when disconnected from the floating device (1). The arrangement 70 will then be either partly or fully in contact with the seabed. Non-buoyant shall therefore be understood such that the weight of arrangement, device or system it relates to, is greater than the weight of the liquid said arrangement, device or system displaces. For very deep water a temporary buoy can however be attached to the upper connection structure after it has been disconnected from the floating wind turbine, and thereby keep the invention floating in the disconnected state.

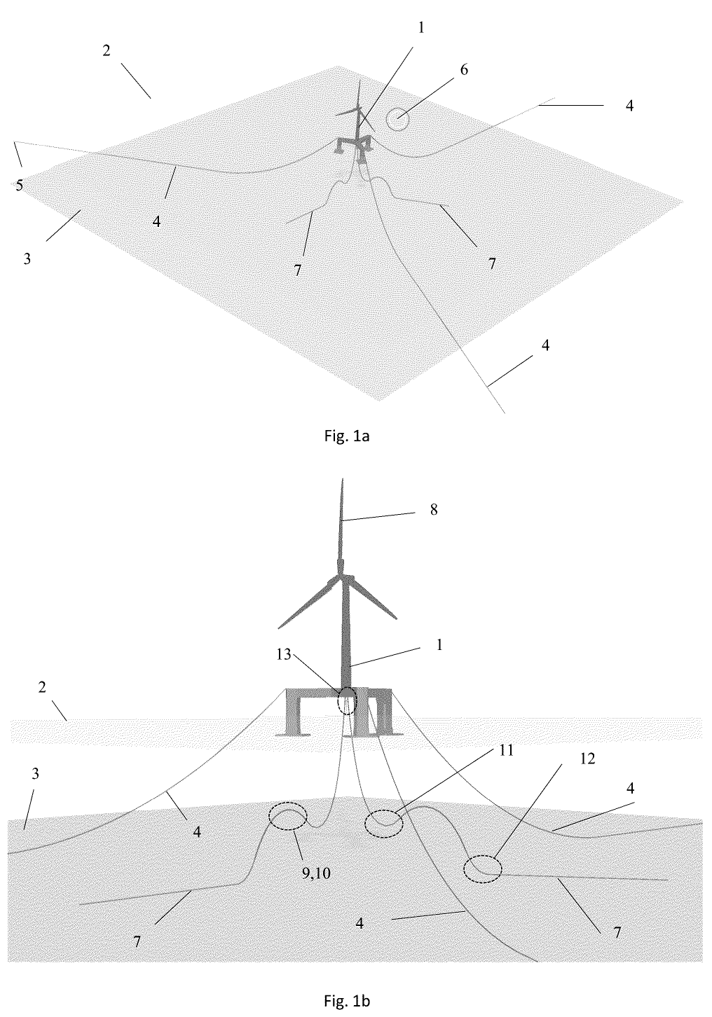

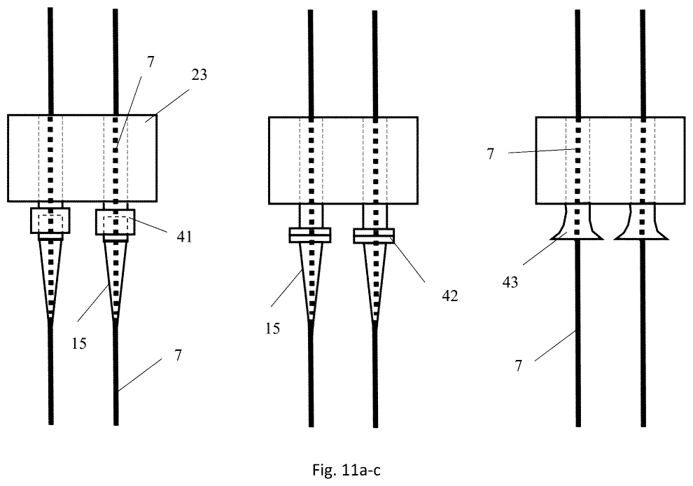

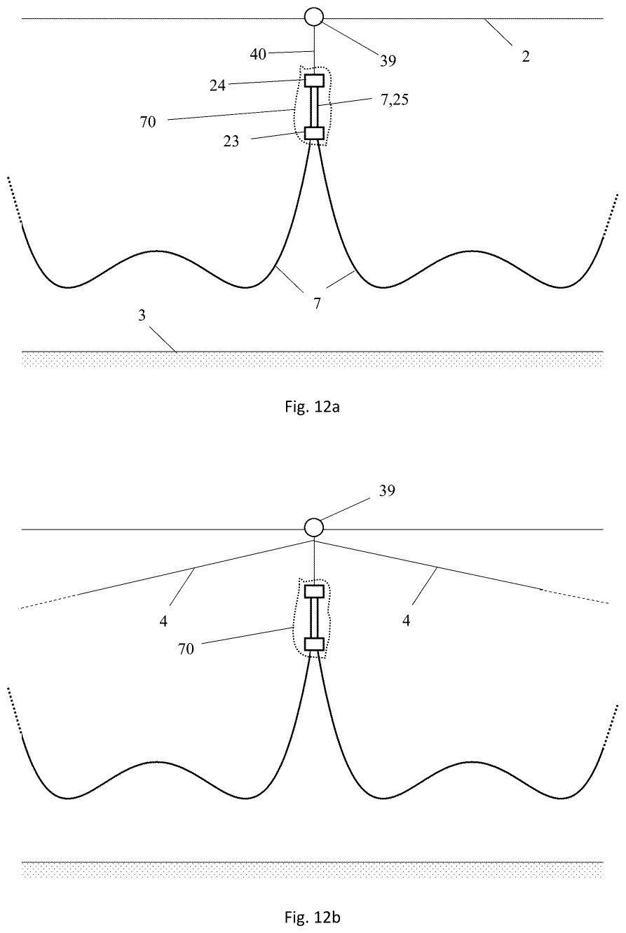

This invention relates to an arrangement or system for connecting power cables 7 to a wind turbine 1 floating on the sea surface 2 and kept on station by mooring lines 4. For shallow water depths the power cables are typically extended from the seabed 3 up to the floating wind turbine in a dynamic configuration such as in FIG. 1a and FIG. 1b, while in deep water the power cables can be configured such that they do not touch the seabed as shown in FIG. 12a and FIG. 12b. The dynamic configuration is such that it has in-built flexibility to absorb the excursions of the floating wind turbine caused by waves, wind and current without exceeding the maximum allowable stresses in the cable. This flexibility is very often obtained with adding buoyancy to provide a buoyancy section 9 along a section of the cable and thereby obtain a wave-shape which can be stretched or compressed depending on the excursion direction. The top of the buoyancy section is typically denoted as the hog bend 10, while the deep sag between the hog bend and the floater connection 13 is typically denoted as the sag bend 11. Another referred area for the dynamic configuration is the touchdown area 12, which is the area where the cable lands on the seabed, both statically and dynamically.

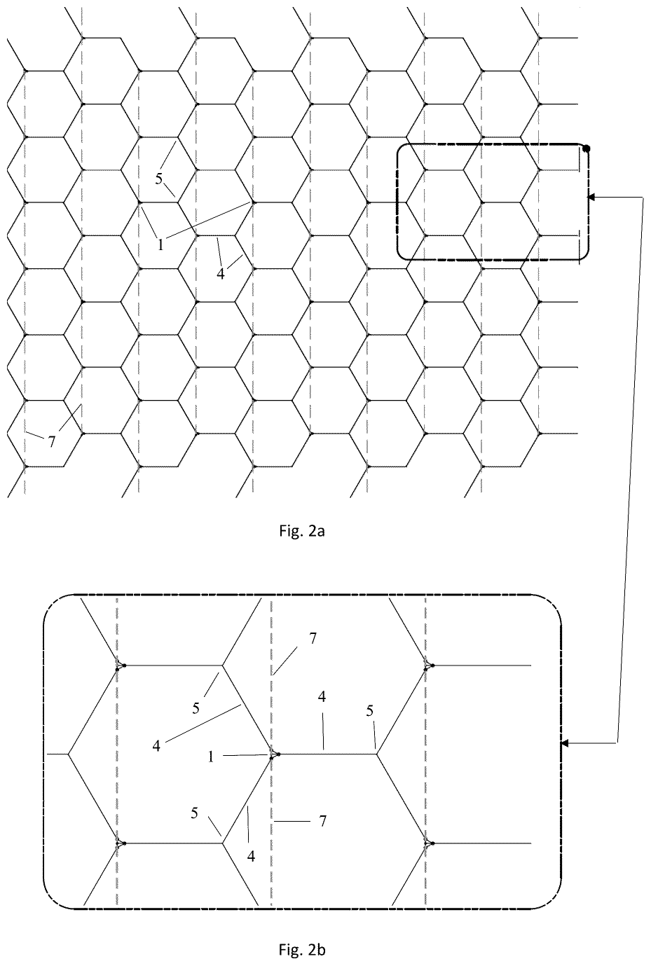

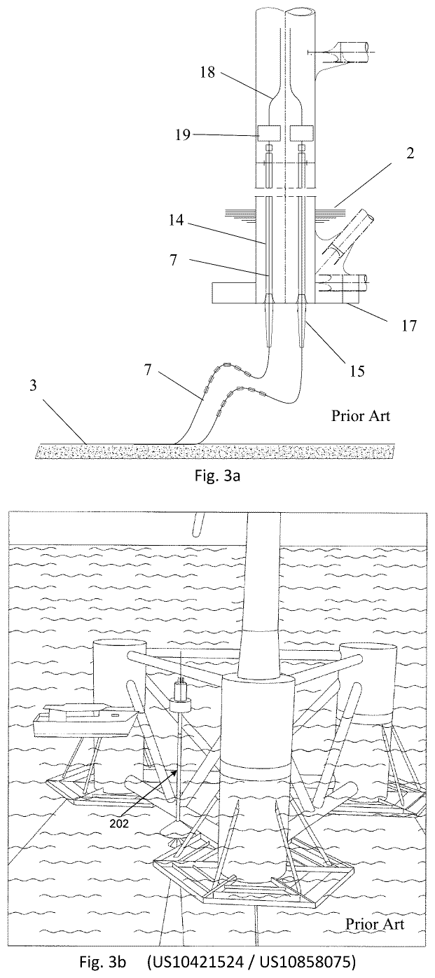

A wind farm often comprises many wind turbines. FIG. 2 shows a typical layout for seventy floating wind turbines 1 with their mooring lines 4 and anchors 5. In this layout anchors shared between several wind turbines are illustrated. The power cables 7 are in this layout routed from one wind turbine to the next implying that the power generated by one turbine is sent to the next, which then sends the power generated by the first turbine and from its own turbine to the third turbine, etc. With this arrangement most turbines will be connected to two power cables, one for importing power and one for exporting power. If one turbine breaks and requires repair at quayside this means that the turbines on the import side cannot provide power to the grid unless the import cable and export cable is electrically connected before disconnected from the damaged turbine. This is one of the main objectives for the invention, which allows for disconnection with electrical continuity (open circuit) between the import and export cable.

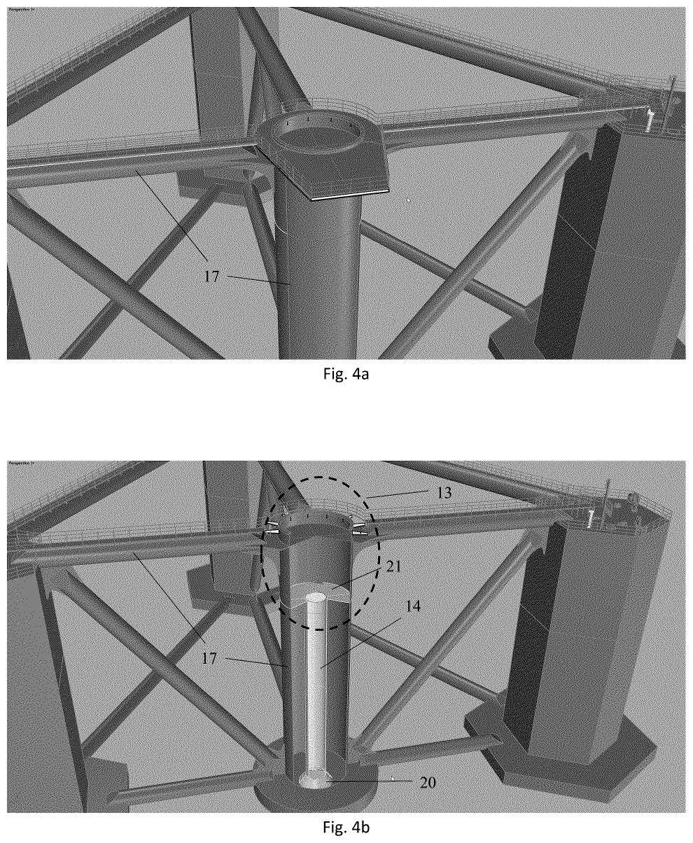

A typical design of the floating wind turbine is based on a semi-submersible hull. An example of such a design is illustrated in FIG. 4a, which shows a four columns floater with three large columns forming a triangle while the fourth column is placed between two of the large columns and carries the wind turbine tower, the nacelle and the rotor. One alternative for the cable hang-off is to pull the cables 7 into a large guide tube 14 located inside the floater structure 17 as shown in FIG. 4b. The guide tube then extends from the bottom of the floater to the hang-off deck 21 located in the hang-off area 13. The lower end of the guide tube will have an entrance structure 20 which fits the lower connection structure 23 of the invention.

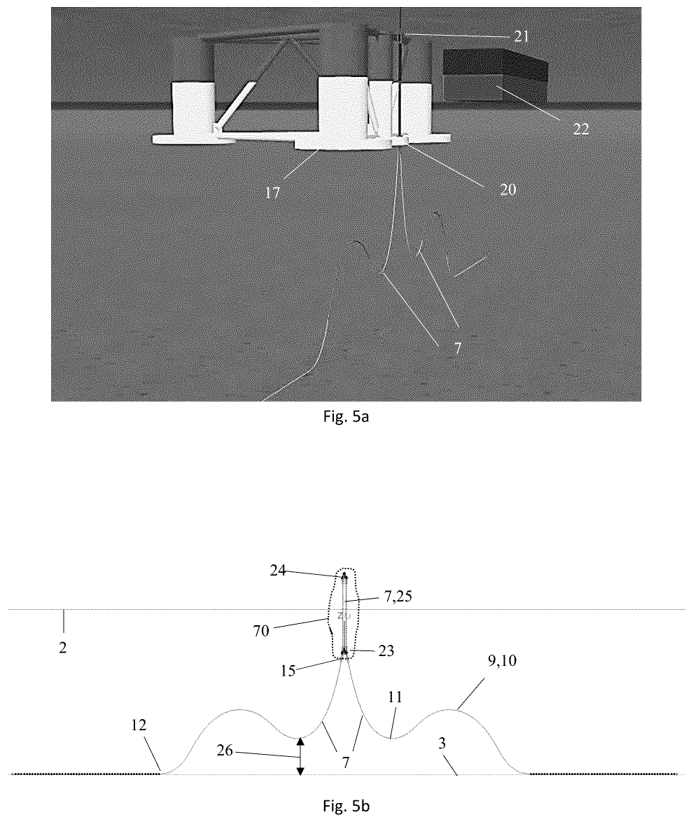

In another embodiment the cables 7 will be hung-off at the outside of the floater structure 17 with an external entrance structure 20 and an external hang-off deck 21 and hang-off area 13. This arrangement is shown in FIG. 5a. FIG. 5b shows a typical dynamic cable configuration connected to the arrangement 70 of the invention that is disconnected from the floating wind turbine while the floating wind turbine is off site. The cables are in this embodiment connected to a lower connection structure 23 via bend stiffeners 15. The cables are then running up inside flexible pipe structures, such as a longitudinal element 25 and axially terminated at an upper connection structure 24.

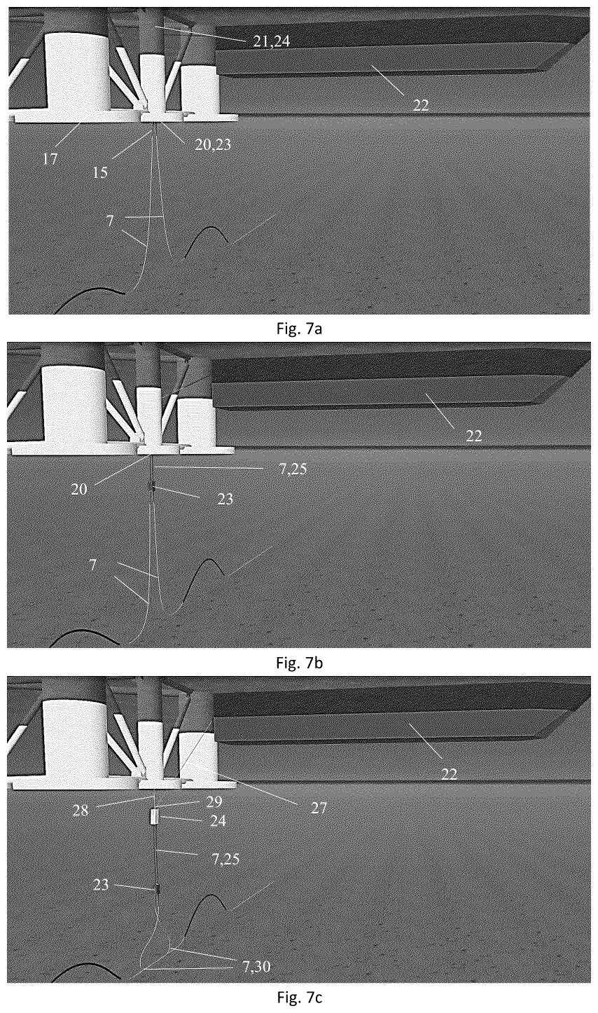

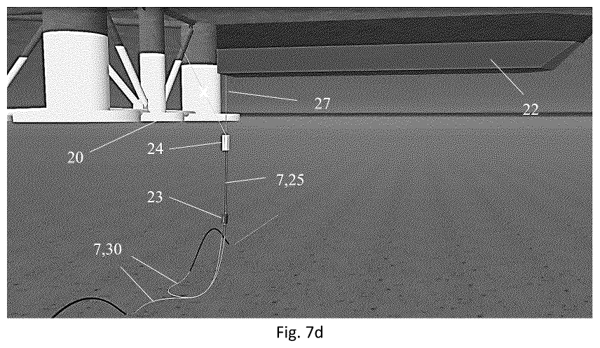

Internal versus external hang-off have their specific pros and cons. With internal hang-off the system is protected from impacts from floating objects, wave actions, etc. since it is safely located inside the floater structure 17. However, for shallow water depths the seabed clearance 26 for the cable configuration may not be sufficient to avoid significant touchdown of the sag bend 11 during disconnection and connection as shown in FIG. 7c. Reason is that the uppermost part of the upper connection structure 24 must be lowered below the lower guide tube part 20 before a handover between the floater wind turbine 1 and the supporting vessel 22 can be done. This is to a large degree avoided with an external hang-off since the handover of the system can be done when the upper connection structure 24 is much closer to the sea surface 2. For external hang-off the system is however less protected from wave actions and potential impact from floating objects. The flexible structural element 25 between the lower and upper connection structure may also need to be lengthened since the hang-off deck 21 may have to be placed at a higher elevation compared to internal hang-off. Both internal and external hang-off is fully feasible and the selection of location for the hang-off will be project specific. The guide tube 14 can be placed outside of the main floater structure 17. This arrangement is in this context still defined as an internal hang-off. For this description the invention is mainly exemplified as an internal hang-off.

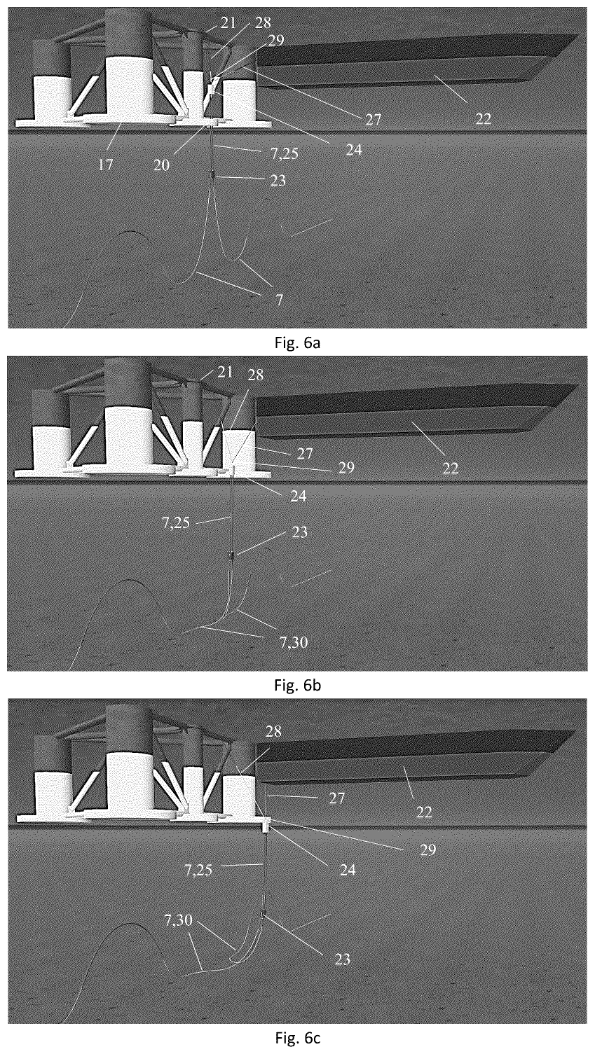

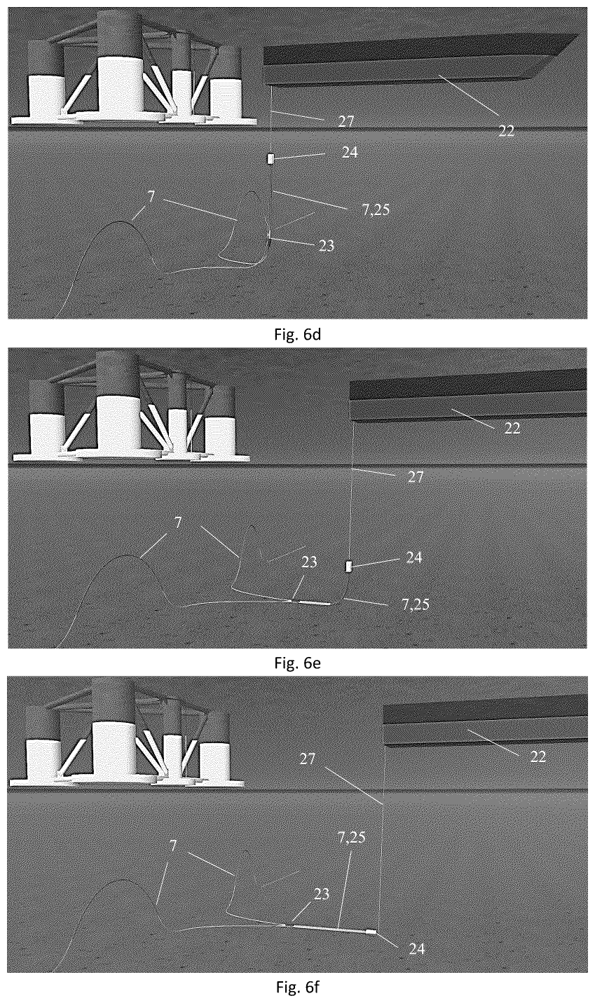

The main steps for disconnecting the system from an external hang-off on the floating wind turbine 1 is shown in FIG. 6. For connection the same main steps applies but in opposite order. FIG. 6a shows the initial lowering of the system using a winch or similar on the floating wind turbine. The winch can be a permanent winch or a temporary winch or it could be an arrangement of sheaves which routes the winch/connection rope 28 to a supporting vessel 22. In FIG. 6a the upper connection structure 24 has been lowered from the hang-off deck 21 to an elevation just below the sea surface 2. In this example the sag bend 11 of the cable 7 has still positive clearance 26 to the seabed 3. FIG. 6b shows a later stage where the upper connection structure 24 has reached an elevation close to the baseline of the floater structure 7. Handover of the weight of the invention from the winch line 28 to the floater structure 17 to the winch line 27 to the supporting vessel 22 has started. The sag bend 11 of the cable has significant contact 30 with the seabed 3. If the cable stresses in this scenario is unacceptable one potential solution is to do the handover between the floater and supporting vessel at a higher elevation. In FIG. 6c all the weight of the system has been transferred to the supporting vessel 22 and the associated winch/connection line 27, and a smooth lay-down of the system onto the seabed has started. The winch/connection line 28 to the floater can now be disconnected from the connection point 29 and retrieved back to the floater 17. In FIG. 6d the lay-down has come further and the lower connection structure 23 is about to touch the seabed. In FIG. 6e the lower connection structure 23 is resting on the seabed and laydown of the cable 7 sections between the lower and upper connection structure and the flexible structural element 25 is ongoing. This is the part of the lay-down process where the flexible connection 25 between the lower connection structure 23 and upper connection structure 24 provides an important feature. With a rigid connection between the lower and upper connection structure the risk for damaging the rigid connection, the cables 7 and the bend stiffeners 15 during laydown is very high. In FIG. 6f the entire system is resting on the seabed and the winch/connection line 27 can either be disconnected from the upper connection structure 24 or buoyed off at mid-depth or close to the sea surface 2 for later pick-up.

FIG. 7a, FIG. 7b, FIG. 7c and FIG. 7d show the same as FIG. 6a, FIG. 6b, FIG. 6c and FIG. 6d but based on internal hang-off of the invention instead of external hang-off. Due to the need to lower the upper connection structure 24 fully below the lowermost point of the lower guide tube part 20 before connecting the connection line 27 to the connection point 29, and thus before transfer of the weight of the system to the supporting vessel 22, there is a potential issue, especially for very shallow water, that the power cable 7 gets an unacceptable touchdown 30 with the seabed. This is an issue only for water depths where the initial seabed clearance 26 is much lower than the lowering distance inside the guide tube 14. The lay-down steps after FIG. 7d are the same as the steps shown in FIGS. 6e and 6f.

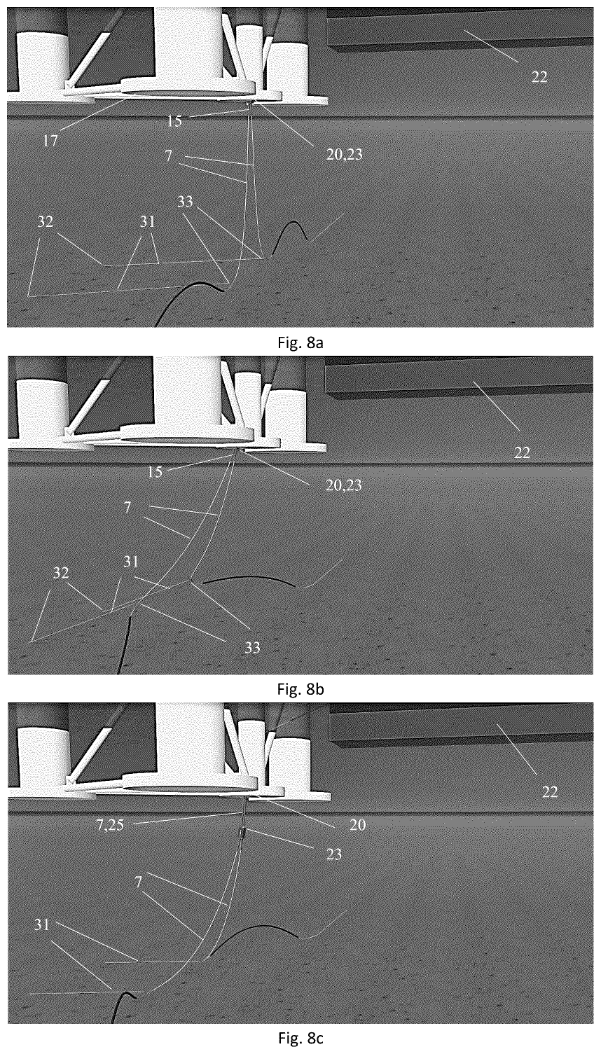

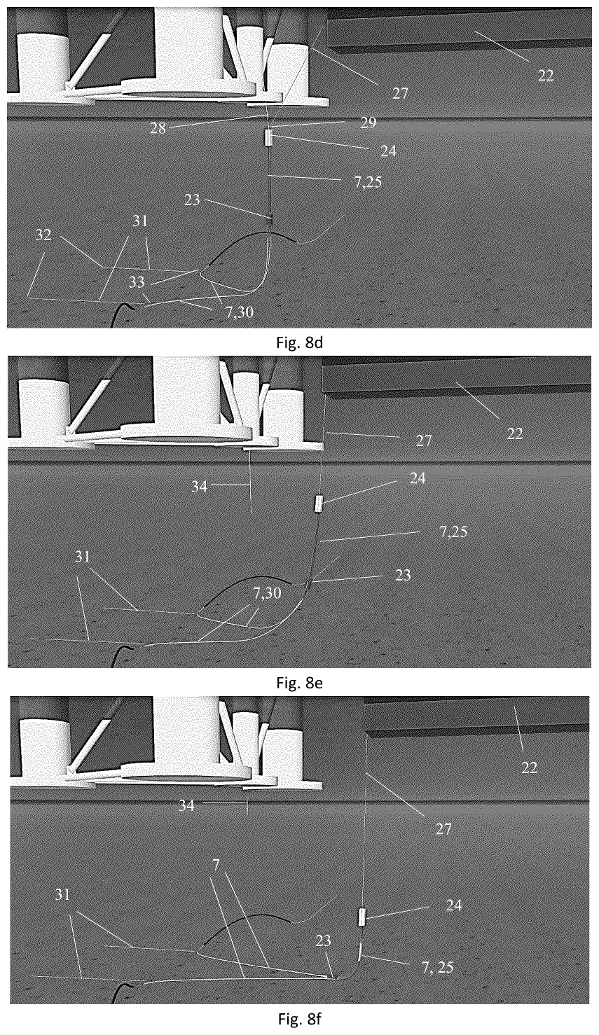

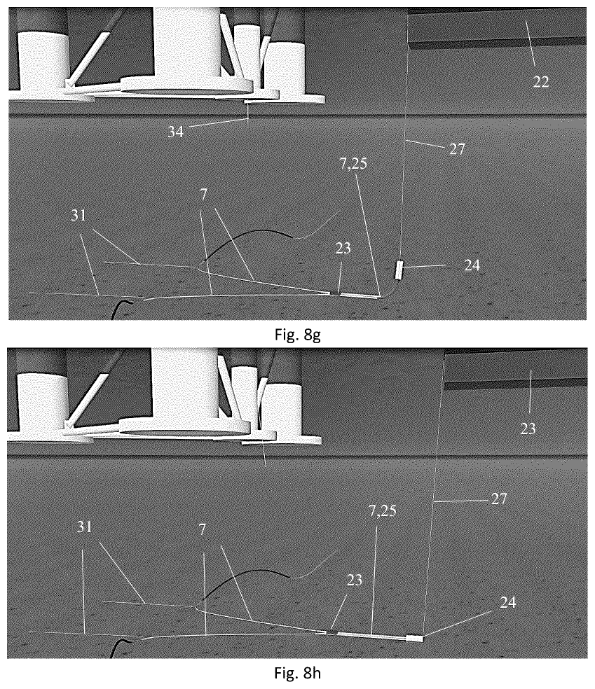

For water depths where the initial seabed clearance 26 is not sufficient to avoid unacceptable touchdown 30 of the cables 7 one solution is described next and shown in FIG. 8. In this arrangement a temporary line 31 is attached to the cable 7 at a point 33 before the lowering process of the system starts. The temporary line 31 is at the other end connected to a temporary clump weight (anchor) 32, which is placed on the seabed 3 at a position where the cable 7 has been given a displacement opposite the lay-down direction for the invention. This reduces the critical touchdown area 30 and acceptable cable stress will be obtained. FIG. 8a and FIG. 8b show the attachment of the temporary clump weight and the associated cable displacement before starting the lowering process. FIG. 8c to FIG. 8h show similar lay-down steps as shown in FIG. 6 and FIG. 7.

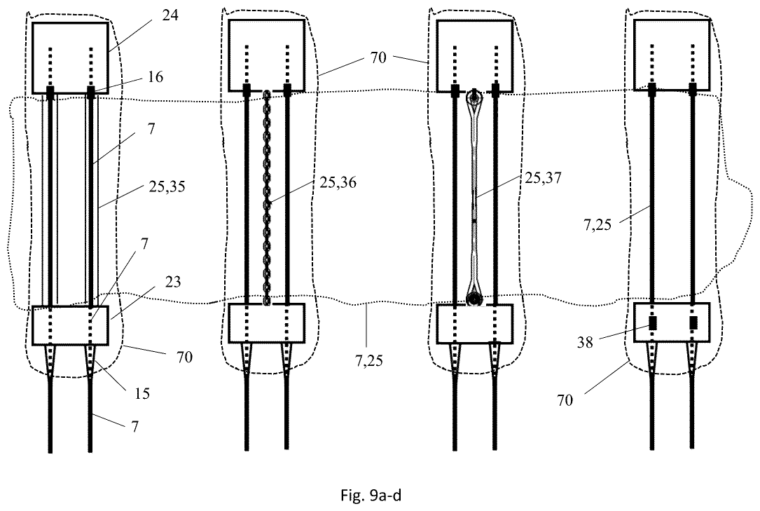

The flexible structural element 25 joining between the lower connection structure 23 and the upper connection structure 24 can be done in many ways, whereof four alternative arrangements are shown in FIG. 9. The objective of this flexible structural element is to simplify the lay-down process of the invention on the seabed. The minimum required flexibility is in the rotational degree of freedom around an axis transverse to the lay-down direction of the system. This can be obtained by an element with zero or low bending stiffness or an element hinged at intermediate length positions and/or at upper and lower end. More specifically, a flexible structural element is herein defined as an element where the allowable bending radius of the flexible structural element 25 relative its length is less than 0.6. For example, if the flexible structural element 25 has a length of 20 m then it is considered flexible if the element as a whole can be curved to a radius less than 12 m without exceeding its structural capacity. This length is for exemplification of the relationship between the length and bending radius only, and it should be understood that the length of the structural element 25 could be any required length. For the connected scenario the lower connection structure 23 will for all arrangements transfer bending moments and shear loads from the cable 7 into the floater structure 17 since the lower connection structure 24 is then fixed from rotation via the interface structure 20 of the floater structure 17.

FIG. 9a shows an arrangement where the flexible structural element 25 is a flexible pipe 35. The cable 7 is located inside this flexible pipe 35. In this embodiment the cable is protected by the flexible pipe 35 from external damage which is beneficial both for the lay-down process and for protection against wave actions, and protection from floating objects in case of external hang-off. All tension loads between the lower connection structure 23 and the upper connection structure 24 are then via the flexible pipe 35. The cable 7 is axially decoupled from the bend stiffener 15, the lower connection structure 23 and the flexible pipe 35. The cables 7 are axially terminated to the upper connection structure 24 at a termination point 16, implying that the cable tension loads due to wave actions, floater excursions and floater motions are transferred directly into the upper hang-off structure 24, except for frictions loads between cable 7 and bend stiffener 15 and between cable and lower connection structure 23, which will be taken by the lower connection structure 23. Typical pipes that can be used as the flexible pipe 35 are bonded hoses and unbonded risers. These pipes have low bending stiffness, but the bending stiffness can be adjusted to some degree in the design process to give an optimized lay-down procedure with reduced risk for overbending of the cable 7 and overbending of the flexible pipe 35. Other type of suitable pipes are hinged pipes such as vertebrae bend restrictors.

In FIG. 9b and FIG. 9c the flexible element comprises single or multiple parallel chain segments 36 or rope segments 37. The ropes can be both synthetic ropes or steel wire ropes. In both these arrangements the cable 7 is unprotected between the lower connection structure 23 and upper connection structure 24. As in FIG. 9a the cable 7 is only axially fixed to the upper connection structure 24.

FIG. 9d shows an arrangement where the cable 7 is used as the flexible structural element 25. However, in this arrangement the cable 7 is axially fixed to both the upper connection structure 24 and to the lower connection structure 23. Axial fixation 38 to the lower connection structure 23 can be done via the bend stiffener 15 or directly between the cable and the lower connection structure.

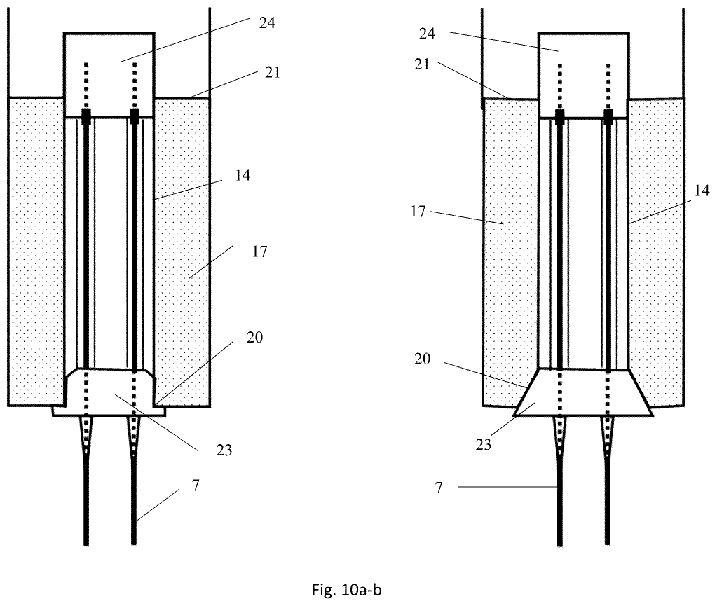

The lower connection structure 23 can be fixed in rotation relative the floater structure 20 in several ways. Two alternatives are sketched in FIG. 10. FIG. 10a shows an arrangement where the guide tube 14 has a constant cross section over the entire length. The lower connection structure 23 then has a shape with a short conical shape at the top for smoother entrance during pull-in, a section with vertical sides to provide a moment-arm effect preventing rotation due to bending moments and shear loads from the cables 7, and a bottom plate with larger area than the vertical section preventing the lower connection structure 23 to enter fully into the guide tube 14. Another arrangement is shown in FIG. 10b where both the floater structure 20 and the lower connection structure 23 has a conical shape providing the same overall objectives as the arrangement shown in FIG. 10a. Neither of these arrangements have any locking mechanisms between structure 23 and structure 20. In another embodiment these two structures may be mechanically locked to each other, but these mechanisms must be remotely operated and will be in a marine environment with limited access for maintenance. The preferred arrangement is thus an arrangement where subsea locking devices between the lower connection structure 23 and structure 20 are avoided.

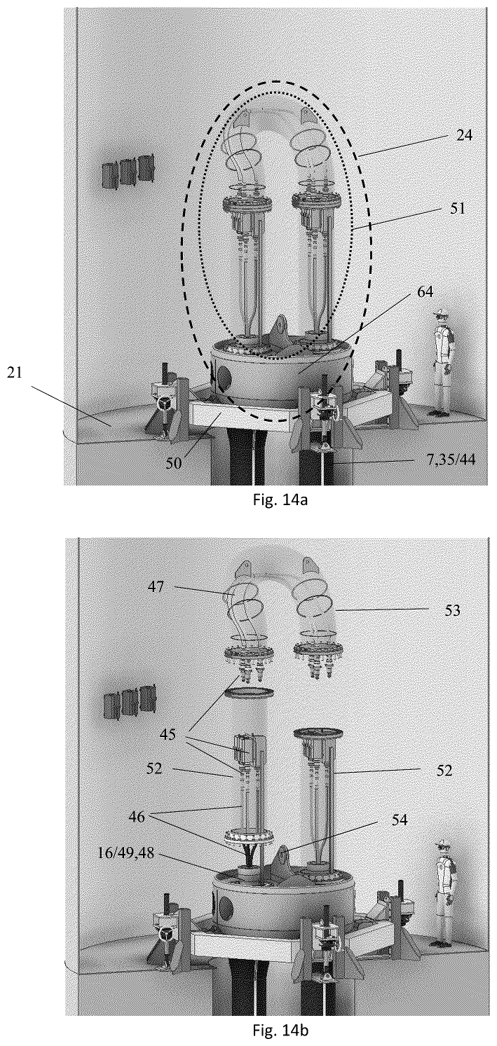

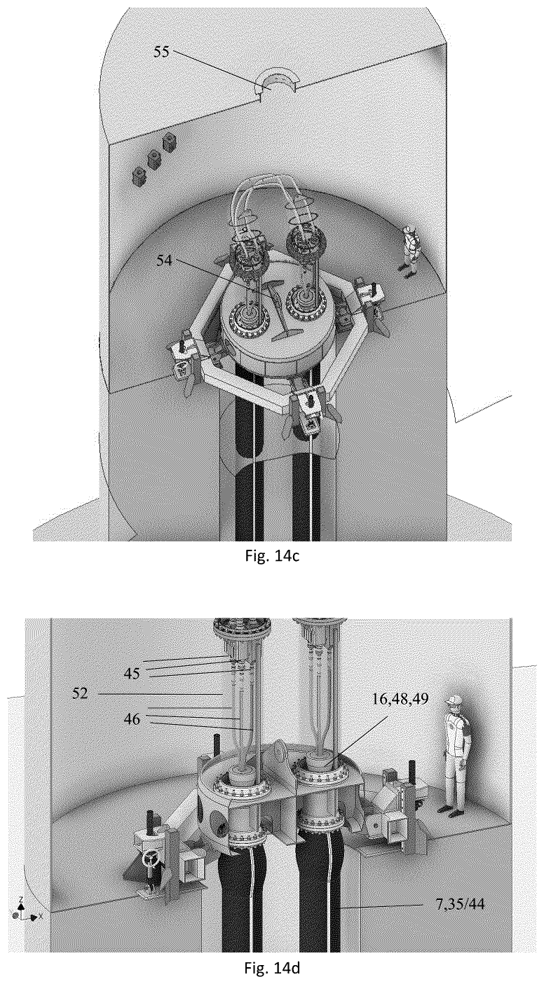

For applications with severe metocean conditions and thus extreme floater motions the most likely arrangement to avoid overbending of the cable close to the lower connection structure 23 is to use a bend stiffener 15. A bend stiffener will transfer the bending moments and shear loads between the lower connection structure 23 and the cable 7 in such a way that the allowable curvature of the cable is not compromised. The bend stiffener can however be attached to the lower connection structure either via a bend stiffener latching mechanism 41 as shown in FIG. 14a or via a bolted flange 42 as shown in FIG. 14b. The bolted flange 42 will require manual connection while the bend stiffener latching mechanism 41 can be fully automatic or remotely operated or a combination thereof. For benign metocean conditions the allowable curvature and stresses of the cable close to the lower connection structure can be maintained by a bellmouth as shown in FIG. 11c, alternatively via a vertebrae bend restrictor.

For deep water the cables 7 may be positioned at mid-depth between the different floating wind turbines 1 without being in contact with the seabed 3 as shown in FIG. 12. Even if the cables 7 are partly resting on the seabed in deep water the water depth itself may give a preference for not storing the invention on the seabed while disconnected from the floating wind turbine. In both these scenarios the system 70 can be attached to a temporary buoy 39 after the system 70 has been disconnected from the floating wind turbine. The temporary buoy 39 is in this embodiment connected to the upper connection structure 24 via a connection line 40, and the buoy 39 will then hold the system clear from the seabed. FIG. 12a shows an illustration of such an arrangement. FIG. 12b shows a similar arrangement but here it is foreseen that the disconnected mooring lines 4 from the floating wind turbine 1 and the disconnected part 70 of invention are attached to the same buoy 39.

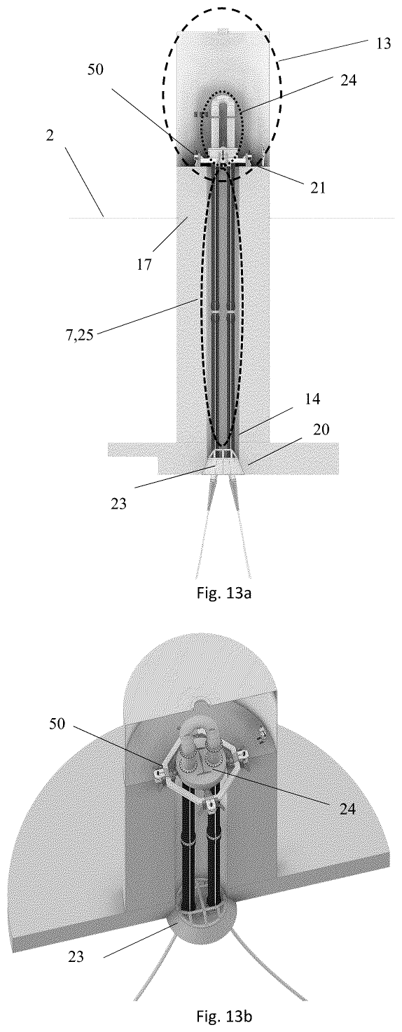

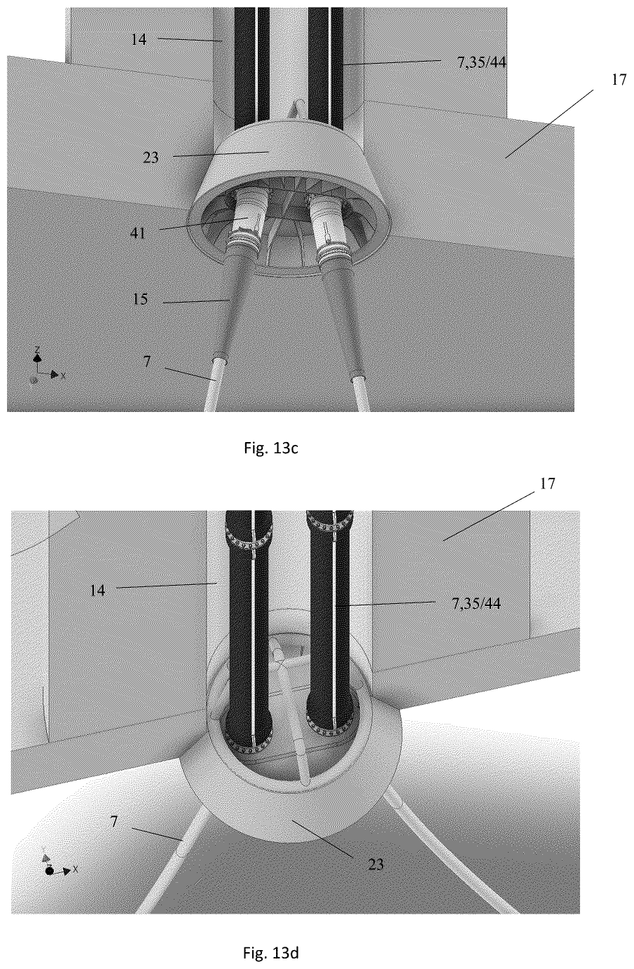

FIG. 13 to FIG. 17 show the invention based on the arrangements shown in FIG. 9a, FIG. 10b and FIG. 11a in more detail. The principal of the invention is herein illustrated by an arrangement with two cables 7 only, but the invention can be modified to more than two cables without changing the features of the invention. FIG. 13a shows the overall arrangement with the lower connection structure 23,

the upper connection structure 24, the power cables 7, the flexible pipes 25, the guide tube 14 including the lower part 20, the hang-off deck 21, the locking arrangement 50 for the upper connection structure and the overall hang-off area 13. FIG. 13b shows the same as FIG. 13a but from another view angle. FIG. 13c and FIG. 13d show the lower part of the intervention from two different view angles.

FIG. 14a shows the upper arrangement of the invention. The upper connection structure 24 comprises the main cable hang-off structure 64 and the compartment 51. Compartment 51 encapsulates the core cables of the power cable 7 and the electrical connectors. In one embodiment the compartment 51 is watertight since the electrical connectors available in the market today are not designed for being exposed to the water pressure at the seabed. However, with qualified subsea connectors suitable for significant external water pressure this compartment can be opened towards the sea and thus allowing a simpler design of compartment 51. The provided description of the invention is however based on a watertight compartment since this is the most likely scenario until qualified subsea connectors are available. Further, since circular pipes have high capacity against external pressure a compartment made of rigid circular pipe sections has been selected as the preferred arrangement. Alternative designs such as watertight box structures can also be applied.

As shown in FIG. 14b the compartment 51 is divided into two straight pipe sections 52, which are connected to the hang-off structure 64 around and above the cable hang-off/termination 16/49. Both the cable hang-off/termination 16/49 and the pipe section 52 are equipped with seal arrangements to prevent water ingress into the compartment 51. A detachable pipe bend 53 is mounted on top of the pipe sections 52.

The cable cores 46, which are exiting the cable at the cable termination runs inside the pipe sections 52 up to the electrical connectors 45. After the upper connection structure 24 has been fully hung-off in the locking arrangement 50 the pipe bend 53 is detached from the pipe sections 52. When the pipe bend has been lifted a limited distance the electrical jumpers 47 inside the pipe bend are disconnected from the cable cores 46. The pipe bend with the jumpers can then be taken away. With disconnected cable jumpers 47 there is no electrical connection between the import and export cables 7. To obtain electrical connection cables from the switchgear on the wind turbine are connected to the cable cores 46, and thereby establishing electrical connection between the import cable and the export cable as well as connection between the export cable and the power generation from the wind turbine.

FIG. 14c shows the same as FIG. 14a but from another view angle. Note the location of the connection point 54 for the pull-ropes/connection lines 27 and 28. This connection point is positioned close to the effective center of gravity for the upper connection structure 24 in a submerged state. This location then allows the upper connection structure 24 to change from a vertical orientation to a horizontal orientation with minimum of applied forces and thus low risk for overbending the cables 7 and the flexible structural elements 25/35 during the lay-down on the seabed. In this embodiment the pipe bend 53 is bent in two directions. This is to manage the physical interface with the pipe sections 52 and to allow clearance to the pull-rope, which is attached to the connection 54, during disconnection and connection operations of the system. With a winch located outside the hang-off area 13 the pull-rope may enter into the area through an opening 55 in the deck above the hang-off deck 21. FIG. 14d shows the same as FIG. 14c but from a different view angle.

FIG. 15a shows the arrangement of pull-ropes/connection lines between the upper connection structure 24 and the floater structure 17 and the supporting vessel 22. The lower part 56 of this arrangement is at one end connected to the attachment point 54 and at the other end to a link or soft eye 57. The length of the lower part 56 is such that the link 57 will be above compartment 51 during lowering and lifting. The lines 27 and 28 can then be detached and attached with a remotely operated vehicle with no or minor limitations on the accessibility. FIG. 15b shows the rope arrangement when the system is resting on the seabed. In this state the pipe bend 53 is pointing downwards. Overall length 66 of the system will typically be in the range 10 to 40 meter but the system can be made both shorter and longer.

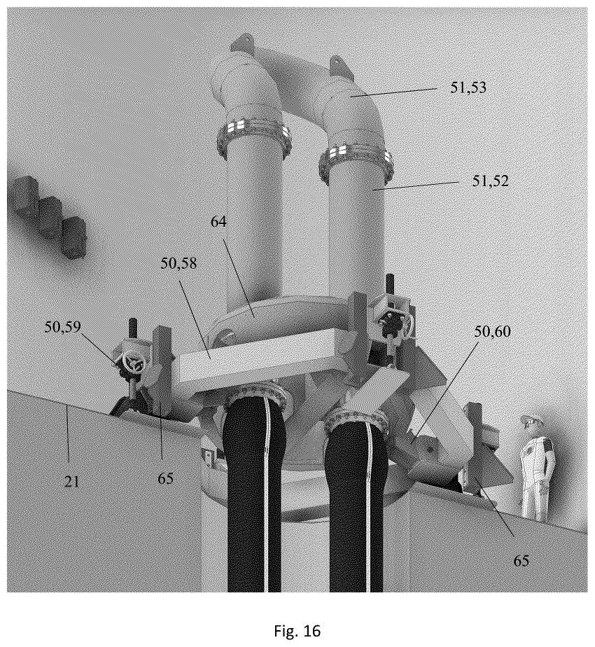

FIG. 16 shows the locking arrangement 50 for the lower part 64 of the upper connection structure 24 to the hang-off deck 21. The locking arrangement 50 comprises the main hang-off frame 58 with guides 65, a set of hinged pads 60 and a set of jacks 59. The hinged pads 60 are connected to the main frame 58, while the jacks 59 are fixed to both the hang-off deck 21 and the frame 58. The guides 65 are fixed to the hang-off deck 21 and prevents the frame 58 to move in the horizontal plane. The jacks 59 can be manually operated and driven, hydraulically driven or electrically driven.

The hinged pads 60 are arranged as self-latching devices such that it is only the position of the upper connection structure 24 which activates these pads and secures the upper connection structure 24 onto the hang-off frame 58. The position of the upper connection structure 24 is controlled by the winch via the winch line. When the hinged pads 60 are engaged the load on the winch can be relieved and the winch line can be removed. The jacks 59 can then be used to lift the frame 58 to obtain the required pre-tension in the structural elements 25. When disconnecting the same steps can be followed but in opposite order. A specific action related to disengaging the hinged pads 60 will however be required. Disengaging the pads can be done by manually lifting these when the upper connection structure 24 is lifted sufficiently with the winch. In another embodiment the disengagement of the hinged pads 60 can be done by hydraulics or electrical motors. A pre-tensioned spring element attached to the hinged pad before lifting the upper construction structure is also possible, where the spring lifts the pad clear of the upper connection structure 24 as soon as the weight of the upper connection structure 24 onto the pad 60 is removed and as soon as the upper connection structure 24 is lifted sufficiently clear of the pads 60.

In another embodiment the hinged pads 60 can be remotely operated to open and closed position. A release mechanism can also be incorporated into these hinges such that the system 70 can be fully disconnected from the floating device 1 based on signal. This may especially be important if a mooring line 4 of the floating device 1 breaks and where the excursion of the floater exceeds the capacity of the dynamic cable 7. Such an emergency disconnect may give damage to the system, but the damage will be less than the damage from not disconnecting.

In addition to fixing the upper connection structure 24 in the vertical plane the hinged pads 60 also have means to guide and fix the upper connection structure 24 in the horizontal plane.

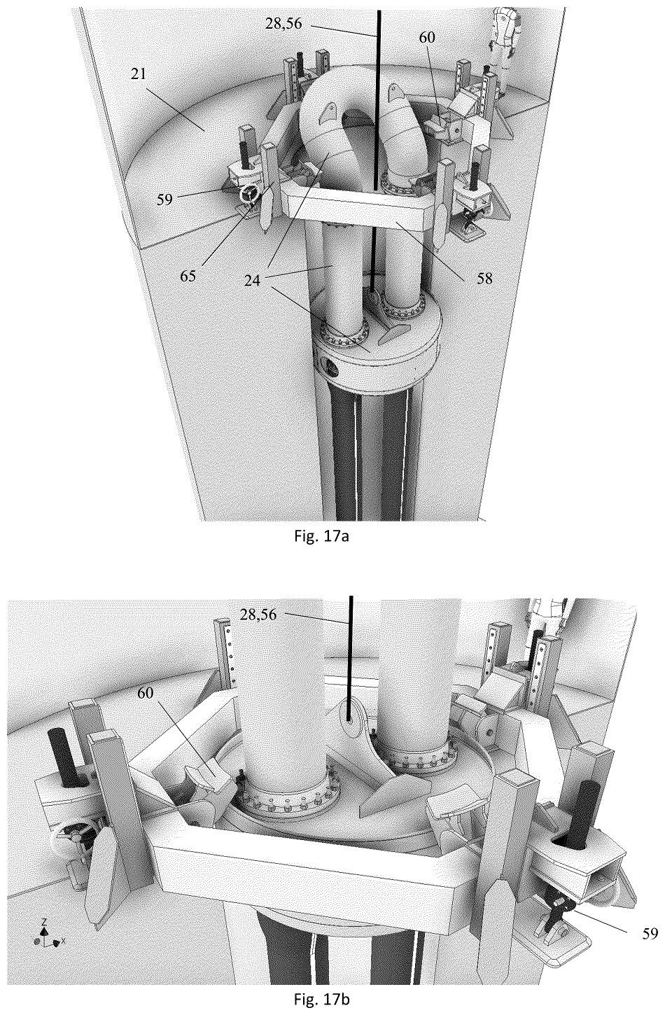

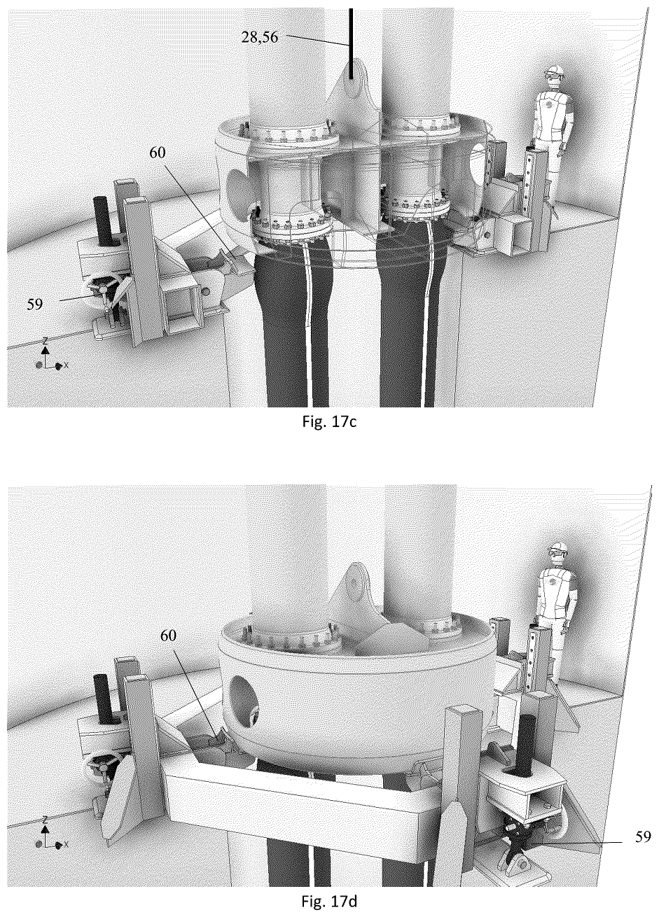

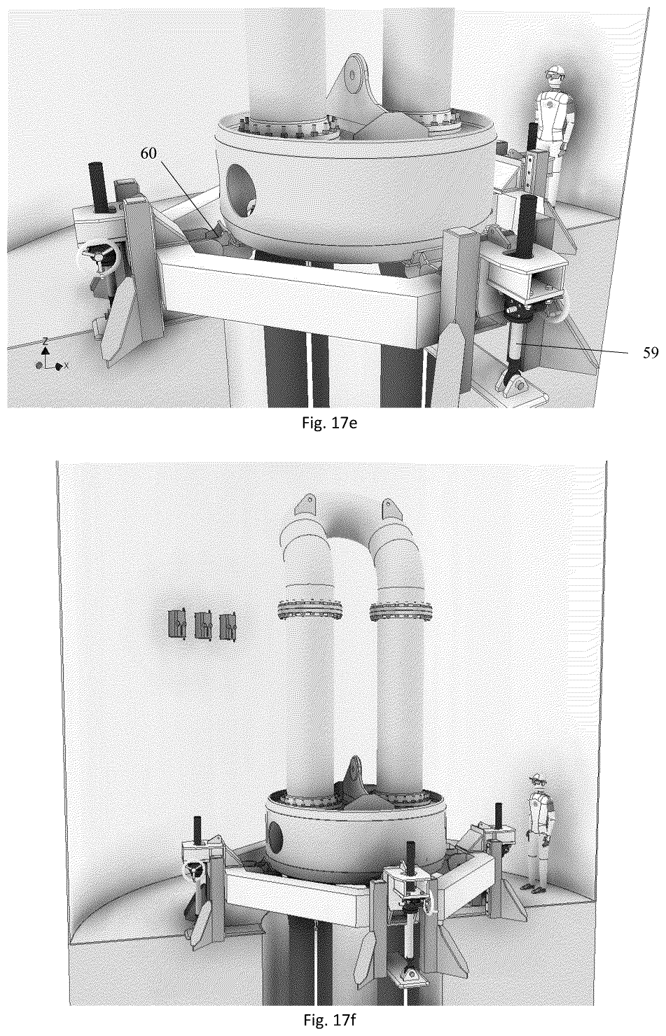

FIG. 17 shows the steps for hang-off of the upper connection structure 24 to the hang-off deck 21. FIG. 17a shows the situation where the top of the compartment 50 is just entering the hang-off area 13 but the lower part 64 of the upper connection structure is still below the hang-off deck 21. At this stage the hang-off 58 is at its lowermost position and the hang-off pads 60 are in their horizontal position. In FIG. 17b the lower part 64 enters the hang-off area 13 and pushes the hang-off pads 60 towards an upright position. In FIG. 17c the winch has pulled the lower part 64 sufficiently high for the landing pads 60 to fall back into their horizontal position to their own weight. FIG. 17d shows the state where the winch has lowered the lower part 64 of the upper connection structure 24 onto the hang-off pads 60 such that the full weight is resting on these and the connection line 28 can be disconnected from the connection point 54. In FIG. 17e the jacks have lifted the frame 58 until the lower connection structure 23 is in full contact with the interfacing structure 20 plus the additional distance for obtaining the target pretension in the flexible structural elements 25/35. This pretension secures contact between the lower connection structure 23 and the interfacing structure 24 with no risk for unintended relative rotations between structure 23 and structure 20.

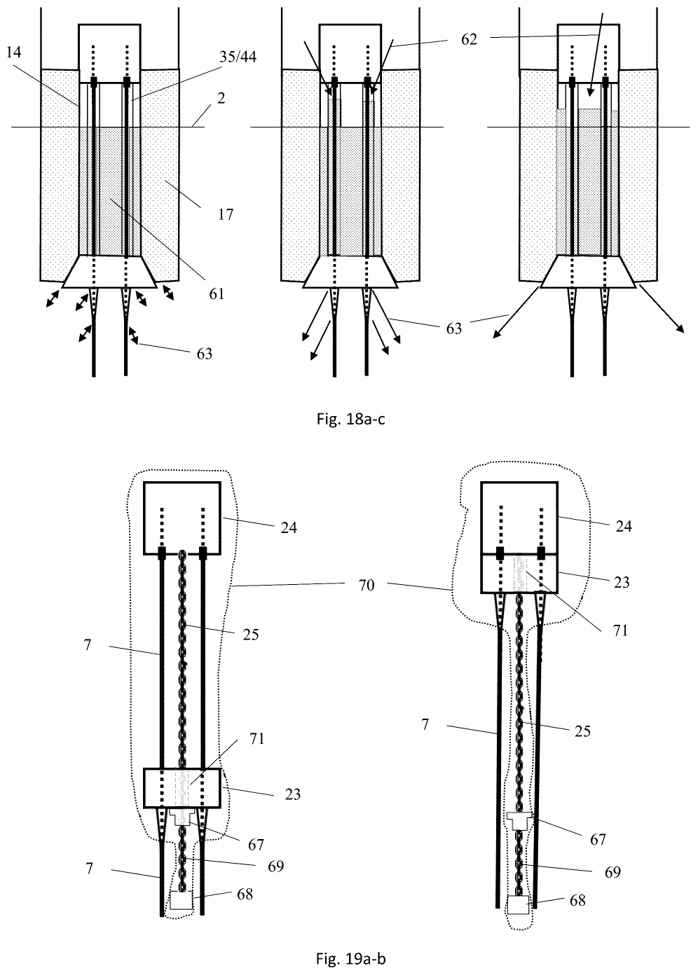

The cables 7 has limited capacities towards high temperatures, and since they generate heat due to the transfer of power proper cooling may be needed. In open sea this is not an issue since the seawater with its large circulation will provide sufficient cooling. However, due to limited circulation of seawater inside the guide tube 14 and inside the flexible pipes 35/44 extra cooling may be required. The lower connection structure 23 is not fully sealed towards the interfacing structure 20, and it is also possible to make openings in structure 23 to increase the water circulation between the guide tube 14 and the open sea and between the inside of the flexible pipe 35/44 and the open sea. In addition, there may be a gap between the cable 7 and bend stiffener 15 (or bellmouth 43) which can allow some circulation of water. This is illustrated in FIG. 18a. If this circulation of water is not sufficient for cooling the cable active cooling can be incorporated into the design. In FIG. 18b cool water is filled into the top of the flexible pipe 35/44. This will generate a circulation since the water will exit at the lower end. A similar arrangement is shown in FIG. 18c but here the water is filled into the top of the guide tube 14. A combination of the arrangements shown in FIG. 18b and FIG. 18c is also possible.

FIG. 9 shows alternative arrangements of the invention where the relative distance between the lower connection structure 23 and the upper connection structure 24 is defined by the length of the flexible structural element 25. The separation distance is only marginally changed between connected and disconnected mode. Only change is due to different axial elongation of the flexible structural element 25 due to possible tensile loads in connected and disconnected mode. In another embodiment the flexible structural element 25 slides inside a funnel 71 in the lower connection structure 23. This arrangement is shown in FIG. 19a for connected mode and in FIG. 19b for disconnected mode. In this configuration the cables 7 are not axially fixed to the lower connection structure 23 but slides inside the structure and inside the bend stiffener 15 or bellmouth 43. A stopper 67 is attached to the flexible element 25. This stopper stops the chain towards the lower connection structure 23 at a pre-defined position such that the separation distance between the lower connection structure 23 and the upper connection structure 24 has a maximum limit similar as the arrangements in FIG. 9. This allows same type of pre-tensioning of the flexible structural element 25 for the connected mode as for the arrangements in FIG. 9. In another embodiment a line 69 can at the upper end be attached to the lower part of the stopper 67 and at the lower end to a weight element 68 to increase the overall submerged weight of the non-buoyant disconnected part 70 of the invention. In the disconnected mode the upper connection structure 24 is lowered to the top of the lower connection structure 23 as shown in FIG. 19b. For the further lowering the lower and upper connection structure will be in physical contact with each other. This contact can be secured in several ways. In the simplest arrangement the lower connection structure 23 is buoyant while the upper connection structure 24 together with the flexible structural element 25 is not. The opposite forces, buoyant lower part versus non-buoyant upper part will then provide contact forces. Additional mechanical securing/locking devices can also be used between the two structures. Since the entire structure 70 is non-buoyant the structure will fall to the seabed 3 and partly or entirely rest on the seabed unless a temporary buoy 39 is attached after it has been disconnected from the floater structure 17.

Damage to a cable 7 can occur for many reasons. Replacement of a cable 7 when the system is connected to the floating wind turbine will then be required. The main steps of the replacement will thus contain the following main steps. Firstly, the cables to the switchgear on the wind turbine are disconnected from the connectors 45. Secondly the pipe 52 and the connectors 45 are removed. A pull head can then be connected to the end fitting of the cable 7 at lower end and to a winch rope at upper end. Cable 7 can then be lowered through the guide tube 14 (or through the flexible pipe 25/35) as soon as the power cable hang-off arrangement 49 and the seal arrangement 48 have been removed. If the bend stiffener 15 is connected to the lower connection structure 23 by a bend stiffener latching mechanism 41 the release of the bend stiffener is done without the need of divers. If it is connected with a bolted flange 42 a diver will be required. For the scenario with bellmouth 43 instead of bend stiffener 15 no involvement will be needed when the cable end fitting passes the lower guide structure 23. The lowering of the cable 7 is continued until it is handed over to the support vessel 22. When a new cable 7 has been installed at site the pull-in and hang-off of this single cable 7 to the upper connection structure 24 is done in the same way as disconnecting but in opposite order.

Since individual cables can be replaced easily when the system is connected to the floating wind turbine then the initial hook-up and commissioning have two main options. In one scenario all the cables 7 can be connected to the invention and stored on the seabed 3 until the floating wind turbine 1 arrives at the site. The invention with the connected cables 7 can then be connected in a single lift according to the procedure described for the system. In another scenario the invention is connected to the floating wind turbine 1 without the cables 7 before it arrives the site. At the site each cable 7 is pulled in individually in the same was as described above for single cable replacement.

In another embodiment the power cables 7 may be fluid lines transferring fluids like water, hydrogen, ammonia, etc. Fluid connectors such as flanges and valves rated for external pressure and seawater submergence are existing technology. Hence, compartment 51 does not need to be watertight and a simpler compartment arrangement can be used.

In an embodiment of the invention, it is provided a connector and system for connecting at least two cables 7 to or from a floating energy converter device 1. The connector may be provided on its own, or in a system. The connector may comprise a lower connection structure 23 and an upper connection structure 24 and at least one longitudinal element 25 joining the lower connection structure 23 and the upper connection structure 24. Two cables 7 may, freely or fixed, run through the lower connection structure 23 and be fixed to the upper connection structure 24 such that the connectable ends 16 of the cables 7 are located at or near the upper connection structure 24. The at least one longitudinal element 25 is a flexible longitudinal element which should be understood that it has a length that is significant for the joining the upper and lower connection structure 24 together at predetermined distance. The lower connection structure 23, the upper connection structure 24, the at least one longitudinal element 25 and the cables 7 should be non-buoyant on their own when fully submerged in a liquid, especially water such as salt water. This should be understood such that the weight of at least the lower connection structure 23, the upper connection structure 24 and the at least one longitudinal element 25 is larger than the weight of the liquid they displaces.

The floating energy converter device 1 may comprise at least two contact points or areas for receiving, contacting and/or connecting to the upper and lower connecting structure. For instance, the floating device may comprise an interfacing structure 20 and a locking arrangement 50, wherein the locking arrangement 50 may be situated a distance above the interfacing structure 20 corresponding to the distance between the upper connection structure 24 and lower connection structure 23. The upper connection structure 24 is connectable to the floating device 1 via the locking arrangement 50, wherein the locking arrangement 50 locks to a part of the upper connection structure 24. The lower connection structure 23 comprises an interfacing surface corresponding to the interfacing structure 20, wherein the interfacing surface is adapted to be in in contact with the interfacing structure 20 when the system is connected to the floating energy converter device 1. The upper connection structure 24 may comprise a connection point 54 for temporary connection of at least a pull line 27,28,56 for use when the connector is lowered or hoisted to be connected or disconnected from the floating energy converter device 1. The connection point 54 may be located between at the least two cables 7 and close to the effective center of gravity for the upper connection structure 24 in a submerged state.

The lower connection structure 23 may comprise at least a cable entrance 15, 43 at its lower end, whereby the cables 7 enter the lower connection structure 23 through the cable entrance 15, 43, as illustrated in FIG. 11a-c. The cable entrance may continue through the lower connection structure 23 as to provide a passage or tunnel for the cables through the lower connection structure 23. The cables 7 may be fixed to the lower connection structure 23 or they may be free such that the lower connection structure 23 can move up or down the cables 7, and thus to and from the upper connection structure 24. The cable entrance 15, 43 may comprises a bend stiffener 15, vertebrae bend restrictor, or a bellmouth 43. The bend stiffener 15, vertebrae bend restrictor, or a bellmouth 43 may be integral parts of the lower connection structure 23, such as by weld or construction, or they may be connected to the lower connection structure 23 via a latching mechanism 41, a bolted flange 42 or other known attachment means.

It should be understood that the invention may be in, and thus comprise, different states, and that it therefore may comprise at least two states, a first state wherein the connection system is connected to the floating energy converter device 1, such as illustrated in FIG. 5a, and a second state wherein connection system is disconnected from the floating energy converter device 1, such as illustrated in FIG. 6e. In the first state the at least two cables 7 are connected to the floating energy converter device 1 and/or to a further energy device, such as previously disclosed. Furthermore, in the first state, the upper connection structure 24 is locked to a part of the floating energy converter device 1 via a locking arrangement 50 and the lower connection structure 23 is in contact with the interfacing structure 20. In the second state, the at least two cables 7 are connected to each other via connection means 45, 46, 47 to constitute a connection, either electronically or fluidly, between the at least two cables 7, as seen in FIGS. 14a and 14b. Furthermore, in the second state the connection system is not attached and therefore disconnected from to the floating energy converter device 1.

The lower connection structure 23 comprises an interfacing surface and the interfacing structure 20 comprises at least a corresponding surface to the interfacing surface, such that when the system is connected to the floating energy converter device 1, such as when in the first state, the shape of corresponding surfaces and structures are adapted to stop the lower connection structure 23 from rotation in relation to the floating energy converter device 1. The shape of the corresponding surfaces will prevent the lower connection structure 23 both from being pulled up the guide tube 14 and prevent the lower connection structure 23 from being rotated around both a horizontal and a vertical axis, if for instance the floating energy converter device 1 shifts its position in the sea. This may occur if the floating energy converter device 1 are exposed to wind and waves on the surface and thus moves relative to the seabed and mooring anchors. As the lower connection structure 23 is seated in the interfacing structure 20 in the first state, the longitudinal element 25 may be pretensioned between the lower connection structure 23 and the upper connection structure 24 by the locking arrangement 50 and the interfacing structure 20. This will obtain a secure contact between the lower connection structure 23 and the interfacing structure 20 when the system is in the first state. Rotation around the vertical axis of lower connection structure 23 relative the floating energy converter device 1 may also be prevented by friction loads between the interfacing surfaces only due to the pretension of the longitudinal element 25. The pre-tensioning of the 25 may be controlled by lifting or lowering the lifting structures 59 of the locking arrangement 50 to increase or decrease the distance between the lower connection structure 23 and the upper connection structure 24 in the first state.

In an embodiment, the upper connection structure 24 comprises a compartment 51, as seen in FIGS. 16 and 17f, wherein the two cables 7 are adapted to be connected together inside the compartment 51 via the connection means 45, 46, 47 when the system is in the second state. This compartment 51 may be attached to the upper connection structure 24 or parts thereof, when the upper connection structure 24 is attached to the floating energy converter device 1 to facilitate the disconnection of the system, thus providing the possibility for an air and watertight compartment for the interconnection of the cables 7 via the connection means 45, 46, 47. Thus, the compartment 51 may be a watertight compartment, such as a tube or box, adapted to house the connection means 45, 46, 47 when the connection system is in the second state. In an embodiment of the invention, the compartment 51 comprises at least an arched section 53 and at least two straight sections 52, wherein the compartment 51 is adapted such that it does not interfere with the connection of temporary pull lines 27, 28, 56 to the connection point 54. This may be achieved with the arched section 53 arching around a vertical axis intersection the center of the guide tube 14. The sections 53, 52 will, when combined form a tube like compartment, enclosing the cables 7 ant the connection means. In another embodiment, the compartment may be a housing of any sort, adapted to house the ends of the cables 7 and any connection means 45, 46, 47. In another embodiment the compartment 51 may be open, which should be understood as not water thigh, but comprising an opening, gap or a non-closed structure, to let any surrounding fluid to enter the compartment 51. This may be done to cool down the internal cables 7 and/or the connection means 45, 46, 47 or to regulate the buoyancy of the system or connector.

In the first state, when the system is connected to the he floating energy converter device 1, there may be provided a locking arrangement 50, as seen in FIG. 14a, comprises multiple hinge pads 60 hinged to the floating energy converter device 1 or parts thereof, wherein the hinged pads are adapted to contact and lock a lower part 64 of the upper connection structure 24, wherein the hinged pads 60 are self-latching during connection of the system to the floating device 1. The hinge pads 60 may comprise a contacting surface, wherein the contacting surface is angled to support the upper connection structure 24 or parts thereof both horizontally and vertically. The locking arrangement 50 may further comprises a main hang-off frame 58 comprising guides 65 fixed to the hang-off deck 21 of the floating device 1 and being adapted to prevent the hang-off frame 58 to move in the horizontal plane, and a lifting structures 59 connected between the hang-off deck 21 and the main hang-off frame 58 adapted to lift the hang-off frame 58 in relation to the hang-off deck 21 to obtain a pre-tension in the longitudinal element 25. The hang-off deck 21 being the deck of the floating device 1 wherein the guide tube 14 then extends to and wherein the upper connection structure 24 may be attached, for instance when in the first state.

In an embodiment of the invention, the guide tube 14 between the hang of deck 21 and the interfacing structure 20 is fluid filled to cool down the cables 7 through the longitudinal element 25. In another embodiment the longitudinal element 25, 35 is fluid filled to cool down the cables 7.

The hinged pads 60, and thus the locking arrangement 50, are disengageable from the upper connection structure 24 during disconnection of the system from the floating device 1 either by a manual operation, via pretensioned spring elements, via hydraulic operation or via electrical motors. The locking arrangement 50 may comprise remote controlled quick release mechanism adapted to release the locking of the hinge pads 60 and thereby the system from the floating device 1, either during emergency quick release operation, such as in bad weather, or as in normal operation when the system is moved from the first state to the second state.

The floating device 1 may comprise different structures to connect the system to the device, such as inside structures or outboard structures. Thus, the system may be connected via the floating device 1 on an inside of the floating device structure 17 or on an outside of the floating device structure 17 when the system is in the first state.

When the system is in the second state, the connector, that may comprise the lower connection structure 23, the upper connection structure 24, at least one longitudinal element 25, the cables 7 or parts thereof, connection means 45, 46, 47 and the compartment 51, may be placed the seabed 3, preferably in the horizontal position. In another embodiment, the connector and/or the system may comprise a releasable and attachable buoy 39. The buoy 39 may be releasable attached through a cable, chain or the like, that is adapted to be releasable attached when the system is in the second state. This will keep the lower and upper connection structure 23, 24 in an upright position and above the seabed 3 when in the second state.

In another embodiment of the invention, the cables may be freely moving through the lower structure 23, and wherein the upper connection structure 24 is adapted to be lowered to the top of the lower connection structure 23, or the lower structure 23 to be raised up to the bottom of the upper connection structure 24. This may be done when the system is in the second state and disconnected from floating energy converter device 1, such that the system can rest on the seabed 3 or above the seabed in a compacted state. To further facilitate this, the longitudinal element may also be movable through the lower structure 23 or collapsible or foldable when exposed to compression. In an embodiment the longitudinal element 25 is fixedly attached to the upper connection structure 24, and movable through a tunnel 71 in the lower connection structure 23. The longitudinal element 25 may comprise a stopper 67, as illustrated in FIGS. 19a and 19b, whereby the lower connection structure 23 is movable displaceable along the longitudinal element 25 between the stopper 67 and the upper connection structure 24. A weighted element 68 may be attached to a lower end or lower part of the longitudinal element 25. For the upper connection structure 24 to be lowered to the top of the lower connection structure 23, the lower connection structure 23 may be buoyant and the upper connection structure 24 non-buoyant such that the upper connection structure 24 can sink towards and adjacent to lower connection structure 23. Even though one part is buoyant, the sum of the system should be non-buoyant.

Although specific embodiments of the invention have been described and illustrated herein, it is recognized that modifications and variations may readily occur to those skilled in the art, and consequently, it is intended that these modifications and variations are covered by the claims.

### REFERENCE NUMERALS

1 Floating wind turbine
2 Sea surface
3 Seabed
4 Mooring line for floating wind turbine
5 Anchor
6 A circle representing the ‘view rotation point’ in the plotting software
7 Power cable from floating wind turbine to other structures or units
8 Rotor of wind turbine, which usually comprises three blades
9 Section of power cable with distributed buoyancy
10 Hog bend of power cable dynamic configuration
11 Sag bend of power cable dynamic configuration
12 Seabed touchdown area of power cable dynamic configuration
13 Cable hang-off area
14 Guide tube
15 Bend stiffener
16 Cable hang-off/termination
17 Floater structure
18 Cable from wind turbine
19 Junction box
20 Lower structure of guide tube for interfacing with lower connection structure
21 Hang-off deck
22 Supporting vessel for cable hook-up to floating wind turbine
23 Lower connection structure
24 Upper connection structure
25 Flexible structural element(s) joining lower and upper connection structure
26 Seabed clearance
27 Temporary connection line to supporting vessel
28 Temporary connection line to hang-off deck area in floater structure
29 Connection point between connection lines
30 Seabed touchdown area of power cable sag bend
31 Temporary hold-back lines
32 Temporary hold-back anchor
33 Connection point between hold-back line and power cable
34 Disconnected connection line to hang-off deck area in floater structure
35 Flexible pipe tether
36 Chain tether
37 Rope tether
38 Cable axial fixation
39 Temporary buoy
40 Connection between temporary buoy and upper connection structure
41 Bend Stiffener Latching Mechanism
42 Bolted flange
43 Bellmouth
44 Flexible hose
45 Electrical connector
46 Cable core
47 Cable core jumper
48 Seal for water ingress
49 Power cable hang-off arrangement
50 Locking arrangement for upper connection structure
51 Compartment encapsulating the electrical connectors
52 Lower part of compartment encapsulating the electrical connectors
53 Upper part of compartment encapsulating the electrical connectors
54 Connection point for connection line
55 Exit/entrance point for connection line to winch
56 Lower part of connection line arrangement
57 Link or soft eye for connecting the lines from supporting vessel and floater
58 Lifting frame of locking arrangement for upper connection structure
59 Jacks for locking arrangement for upper connection structure
60 Hinged pads for locking arrangement for upper connection structure
61 Seawater
62 Filling of water
63 Exit of water
64 Cable hang-off structure of the upper connection structure
65 Guides for lifting frame to allow for only vertical motion of the frame
66 Overall length of the system
67 Stopper for structural element between lower and upper connection structure
68 Weight element
69 Line between stopper and weight element
70 Part of invention disconnected from the floater structure
71 Funnel

1. A connection system for connecting at least two cables to or from a floating energy converter device,
the system comprising
the at least two cables, and;
a lower connection structure,
an upper connection structure, and
at least one longitudinal element joining the lower connection structure and the upper connection structure;
wherein the at least two cables run through the lower connection structure and each of the at least two cables are connected to the upper connection structure and each of the at least two cables comprises a connectable end at the upper connection structure,
the system being non-buoyant, and;
the at least one longitudinal element is a flexible longitudinal element.

2. The system according to claim 1, wherein the system further comprises:
an interfacing structure adapted to be situated on a floating energy converter device, and;
a locking arrangement adapted to be situated on the floating energy converter device, wherein the upper connection structure being connectable to the locking arrangement, and;
the lower connection structure comprises an interfacing surface corresponding to the interfacing structure, wherein the interfacing surface is adapted to be in in contact with the interfacing structure when it is connected to the floating energy converter device.

3. The system according to claim 1, wherein the longitudinal element is at least one flexible pipe enclosing at least one cable, between the upper and lower connection structures.

4. The system according to claim 1, wherein the longitudinal element is a chain segment or other multi-joint structures, a synthetic rope segment or a steel wire rope segment.

5. The system according to claim 1, wherein the upper connection structure comprises a connection point for temporary connection of at least a pull line(s), wherein the connection point is located between the at least two cables and close to an effective center of gravity for the upper connection structure in a submerged state.

6. The system according to claim 1, wherein the lower connection structure comprises at least a cable entrance at a lower end of the lower connection structure, whereby the at least two cables enter the lower connection structure through the cable entrance.

7. The system according to claim 6, wherein the cable entrance comprises a bend stiffener, vertebrae bend restrictor, or a bellmouth.

8. The system according to claim 6, wherein the cable entrance is connected to the lower connection structure via a latching mechanism or a bolted flange.

9. The system according to claim 2, wherein the system comprises at least two states, a first state wherein the connection system is connected to the floating energy converter device and a second state wherein the system is disconnected from the floating energy converter device.

10. The system according to claim 9, wherein the first state, the at least two cables being connectable to the floating energy converter device and/or to a further device, and wherein in the second state, the at least two cables being connectable to each other via connection means.

11. The system according to claim 9, wherein the upper connection structure comprises a compartment wherein the at least two two cables are adapted to be connected together inside the compartment via connection means when the system is in the second state.

12. The system according to claim 11, wherein the compartment is a watertight compartment adapted to house the connection means when the connection system is in the second state.

13. The system according to claim 11, wherein the compartment comprises at least an arched section and at least two straight sections, wherein the compartment is adapted such that it does not interfere with the connection of temporary pull line(s) to the a connection point for temporary connection of at a least pull line(s).

14. The system according to claim 2, wherein the locking arrangement comprises multiple hinge pads adapted to be hinged to the floating energy converter device or parts thereof, wherein the hinged pads are adapted to contact and lock a lower part of the upper connection structure, wherein the hinged pads are adapted to be self-latching during connection of the system to the floating energy converter device.

15. The system according to any claim 14, wherein the locking arrangement further comprises a main hang-off frame comprising guides fixed to a hang-off deck of the floating device and being adapted to prevent the hang-off frame to move in the horizontal plane, and a lifting structure connected between the hang-off deck and the main hang-off frame adapted to lift the hang-off frame in relation to the hang-off deck to obtain a pre-tension in the at least one longitudinal element.

16. The system according to claim 14, wherein the hinged pads are disengageable from the upper connection structure during disconnection of the system from the floating energy converter device either by a manual operation, via pretensioned spring elements, via hydraulic operation or via electrical motors.

17. The system according to claim 14, wherein the locking arrangement comprises a remote controlled quick release mechanism adapted to release the locking of the hinge pads and thereby the system from the floating energy converter device.

18. The system according to claim 9, wherein the corresponding interfacing surface comprises at least a conical section and the interfacing structure comprises at least a corresponding surface to the conical section of the interfacing surface, wherein shapes of corresponding surfaces and structures are adapted to stop the lower connection structure from rotation in relation to the floating energy converter device when in the first state.

19. The system according to claim 9, wherein the system comprises a second locking arrangement between the lower connection structure and the interfacing structure when the system is in the first state.

20. The system according to claim 9, wherein the longitudinal element is pretensioned by the locking arrangement (50) and the interfacing structure to obtain contact between the lower connection structure and the interfacing structure when the system is in the first state.

21. The system according to claim 9, wherein the system is connectable to the floating energy converter device on an inside of the a floating device structure when the system is in the first state.

22. The system according claim 9, wherein the system is connectable to the floating energy converter device on an outside of the floating device structure when the system is in the first state.

23. The system according to claim 9, wherein the system is placeable horizontally on the seabed when the system is in the second state.

24. The system according to claim 9, wherein the system comprises a releasable and attachable buoy, that is adapted to be releasable attached when the system is in the second state after, thereby keeping the lower and upper connection structure in an upright position and above the seabed.

25. The system according to claim 1, wherein the at least two cables are power lines or fluid lines.

26. The system according to any one of the previous claims, claim 2, wherein the floating energy converter device comprising a guide tube between a hang of a deck and the interfacing structure, wherein the guide tube is fluid filled.

27. The system according to claim 1, wherein the at least one longitudinal element is fluid filled.

28. The system according to any one of the previous claims, claim 11, wherein the compartment is open to let surrounding fluid to enter.

29. The system according to claim 9, wherein the at least two cables are free moving through the lower structure, and wherein the upper connection structure is adapted to be lowered to a top of the lower connection structure when the system is in the second state disconnected from floating energy converter device.

30. The system according to claim 29, wherein the at least one longitudinal element is fixedly attached to the upper connection structure, and movable through a tunnel in the lower connection structure, wherein the at least one longitudinal element comprises a stopper, whereby the lower connection structure is moveably displaceable along the at least one longitudinal element between the stopper and the upper connection structure.

31. The system according to claim 30, wherein at least one longitudinal element comprises a weighted element at a lower end of the at least one longitudinal element.

32. The system according to claim 29, wherein the lower connection structure is buoyant, the upper connection structure is non-buoyant, and the lower connection structure and the upper connection structure combined is non-buoyant.

33. A method to connect the connection system according to claim 1, wherein the method comprises
a) leading the upper connection structure, the at least one longitudinal element, the lower connection structure and the at least two cables into a guide tube of a floating energy converter device via temporary pull lines;
b) seating the lower connection structure into an interfacing structure of the floating energy converter device;
c) locking the upper connection structure to the floating energy converter device or parts thereof, via a locking arrangement; and
d) connecting the at least two cables to the of the floating energy converter device or parts thereof.

34. The method according to claim 33, wherein the method comprises after c), lifting up the upper connection structure by the locking arrangement to tension the at least one longitudinal element.

35. A method to disconnect the connection system according to claim 1, wherein the method comprises the steps of:
a) disconnecting the at least two cables from the floating energy converter device or parts thereof;
b) connecting the at least two cables to each other via connection means;
c) disconnecting the upper connection structure from a locking arrangement; and
d) lowering, via temporary pull lines the upper connection structure, the at least one longitudinal element, the lower connection structure and the at least two cables (towards the seabed.

36. The method according to claim 35, wherein the method comprises prior to a), attaching temporary pull lines to the upper connection structure.

37. The method according to claim 35, wherein the method comprises after b), housing the at least two cables or parts thereof and connection means inside a compartment.
